(19) United States
(12) Patent Application Publication
(10) Pub. No.: US 2014/0317185 A1
(43) Pub. Date: Oct. 23, 2014

(54) Systems and Methods for a Contextual Social Network

(71) Applicant: LivingTree, Austin, TX (US)

(72) Inventors: Cullen Childress, Austin, TX (US); Krishna Sai, Bangalore (IN)

(73) Assignee: LivingTree, Austin, TX (US)

(21) Appl. No.: 14/063,138

(22) Filed: Oct. 25, 2013

Related U.S. Application Data
(60) Provisional application No. 61/813,742, filed on Apr. 19, 2013.

(51) Int. Cl. H04L 29/06

(52) U.S. Cl. CPC H04L 65/403
USPC 709/204

(57) ABSTRACT

Disclosed are systems and methods to implement a contextual social network. A contextual social network adds a relationship based at least in part on a context of the relationship. For example, a child may be a student at a school and in turn a student in a particular kindergarten class at that school. As of the next school year the child can maintain the relationship with the school but replace the relationship with the kindergarten class to a relationship with a first grade class. When the child goes to a different school the original school relationship can be replaced with a new one. While the child is in a particular school or class at school the parents of the child have an indirect relationship (e.g., through their child) with the same school and class. The indirect relationship can automatically change as the relationship of the child to the school changes.

### BACKGROUND

Today's social networks revolve primarily around a reference point of a particular user. This model allows a user to express and share opinions and content/media with their direct connections (sometimes referred to as “friends” or “connections”). Having a flat model removes the ability to have contextual interactions. For example, people that have a lot of “friends” in their network could get bombarded with posts from people that are not really that close or important; thus obscuring other interactions (e.g., posts) that may be more important. Disclosed are systems and methods to address these and other issues via embodiments of a contextual social network.

### BRIEF DESCRIPTION OF THE DRAWINGS

Example embodiments of the present disclosure will be more readily understood from reading the following description and by reference to the accompanying drawings, in which:

FIG. 1 illustrates a typical flat social network model.

FIG. 2 illustrates a contextual social network according to one or more disclosed embodiments.

FIG. 3 illustrates roles in a contextual social network according to one or more disclosed embodiments.

FIG. 4 illustrates an example of context member types in a contextual social network according to one or more disclosed embodiments.

FIG. 5 illustrates a possible association of a user with a context of a contextual social network according to one or more disclosed embodiments.

FIG. 6 illustrates an association of one context with another context in a contextual social network according to one or more disclosed embodiments.

FIG. 7 illustrates a network boundary definition in a contextual social network according to one or more disclosed embodiments.

FIG. 8 illustrates a network definition for a first and second user with different policies for a first context and a second context according to one or more disclosed embodiments.

FIG. 9 illustrates a “network-all” boundary definition according to one or more disclosed embodiments.

FIG. 10 illustrates context and sub-context types according to one or more disclosed embodiments.

FIG. 11 illustrates an example contextual network for families and parents raising children according to one or more disclosed embodiments.

FIG. 12 illustrates an example of the contextual social network applied for an enterprise example according to one or more disclosed embodiments.

FIG. 13 illustrates an example of a school as a context according to one or more disclosed embodiments.

FIG. 14 illustrates an example of a class context connected with a school context according to one or more disclosed embodiments.

FIG. 15 illustrates an example of a family & children as a context associated with other contexts (e.g. class) according to one or more disclosed embodiments.

FIG. 16 illustrates formation of a contextual network through invitations and accepts according to one or more disclosed embodiments.

FIG. 17 illustrates communication and interaction for a parent in a children centric contextual network according to one or more disclosed embodiments.

FIG. 18 illustrates communication/coordination for a teacher in a children centric contextual network according to one or more disclosed embodiments.

FIG. 19 illustrates communication/interaction for a school administrator in a children centric contextual network according to one or more disclosed embodiments.

FIG. 20 illustrates a communication stream in a children centric contextual network according to one or more disclosed embodiments.

FIG. 21 illustrates interactions in trusted boundaries according to one or more disclosed embodiments.

FIG. 22 illustrates interactions with users belonging to multiple trusted boundaries according to one or more disclosed embodiments.

FIG. 23 illustrates a teacher interacting with peers through a trusted boundary in the context of a school according to one or more disclosed embodiments.

FIG. 24 illustrates a parent interacting in a trusted boundary in the context of her son's class according to one or more disclosed embodiments.

FIG. 25 illustrates relevance/meaning in interactions—parent example according to one or more disclosed embodiments.

FIG. 26 illustrates relevance/meaning in calendar events according to one or more disclosed embodiments.

FIG. 27 illustrates transience concepts relative to a contextual social network according to one or more disclosed embodiments.

FIG. 28 illustrates a transience example for a parent before re-association according to one or more disclosed embodiments.

FIG. 29 illustrates a transience example for a parent after re-association according to one or more disclosed embodiments.

### DETAILED DESCRIPTION

Having a social network model that is flat removes the ability to have contextual interactions. This limits the ability of these types of networks to be applicable in the real world, where most interactions are contextual. We have our lives where the people we interact with at work, family, school, social environments, etc. are each very different. And we have conversations and interactions specific to each of these “worlds” and the flatness of today's social networks causes several limitations (e.g.,):
Removes this context; and
Limits the interactions due to lack of trust boundaries.

Disclosed are embodiments of a model for a social network that allows interactions between users on a social network based, in part, on contexts so that their interactions have more relevance and meaning to the users. This model enhances the user experience by allowing interactions that preserve the “trust” and “environmental” boundaries that are present in the real world interactions between users when taking into account a context for the relationship.

Terminology

| | |
|---|---|
| User | Any user of a social network with an identity (for |
| | example a user identified by an email address). |
| Context | A primitive that brings together a group of users around a |
| | subject that is meaningful to those users. |
| Relationship | How a user or a context is associated with another user or |
| | context. |
| Interaction | Any content that is created and shared in the context - |
| | could be text messages, photographs, events, static |
| | information, etc. |
| Trust Boundary | Defines who can participate in an interaction on a |
| | context. |
| Relevance/ | Defines why a user sees an interaction (e.g., contextual |
| Meaning | association). |

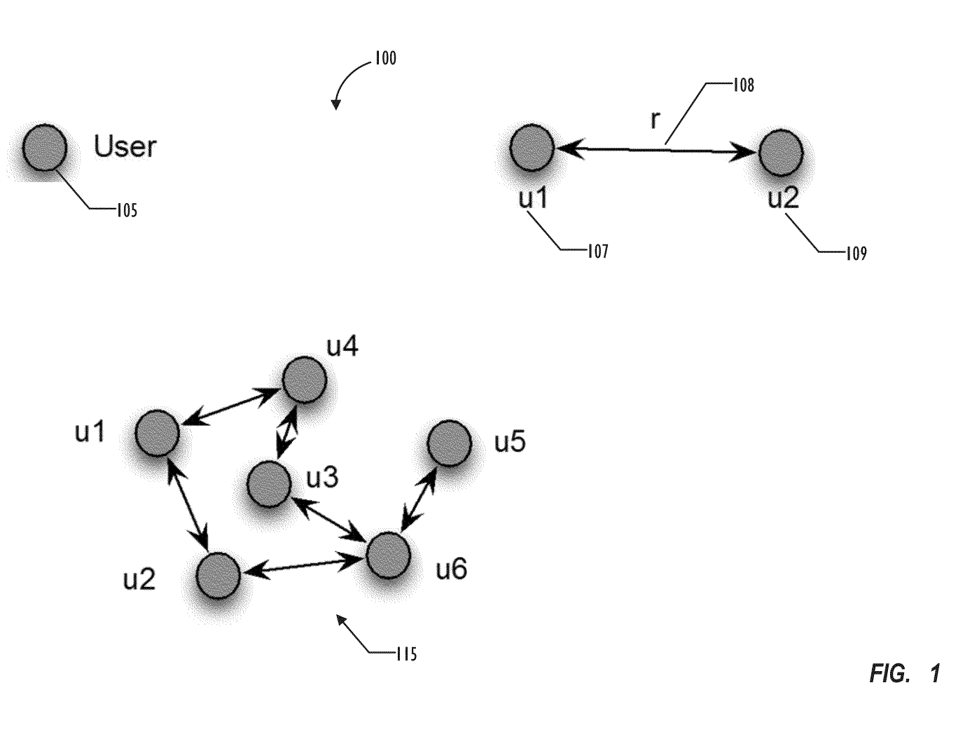

FIG. 1 illustrates a simple model (100) for a flat “user-based” social network. In this model, a given user is illustrated by a shaded circle (105). Users u1 (107) and u2 (109) are connected through a simple relationship “r” (108). In a real world this relationship could just be a “friend” type relationship.

As the network grows, many users can establish relationships with other users and each user could have a set of connections to interact with (a simple example is illustrated by graph 115). Connections can bring an “order” to the relationships. For example in the network represented in graph 115, these relationships may be represented by attributes of Table 1 shown below:

TABLE 1
Interactions in a flat social network

| | | | Third Order |
|---|---|---|---|
| | First Order | Second Order | (Friend of Friend |
| User | (Friend) | (Friend of Friend) | of Friend) |
| u1 | u4, u2 | u3, u6 | u6, u5 |
| u2 | u1, u6 | u4, u3, u5 | u3, u4 |

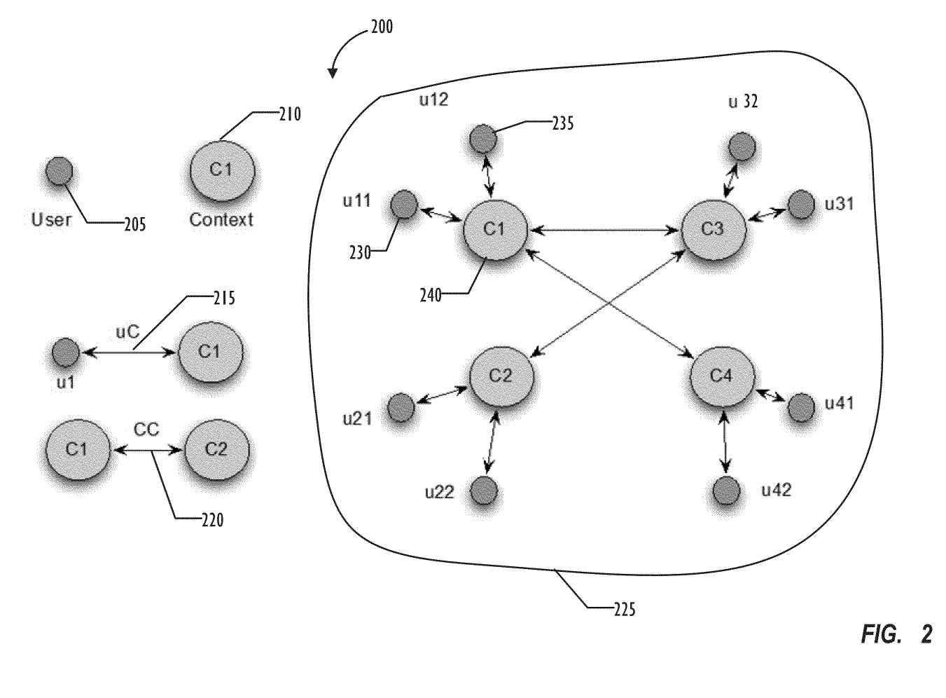

FIG. 2 illustrates, via graphical representation, an example of a contextual social network. In this particular model a user “u” (205) is only associated with another user through a context “C” (210). This is as opposed to being directly related to another user as is typical in the “flat” social network of FIG. 1. There are at least two types of relationships possible within the disclosed contextual social network model. First, a user can be connected to a context as shown in relationship 215. Second, a context can be connected to another context as shown in relationship 220.

These two types of relationships can permit interactions between users to have the following properties in addition to the properties available for users of a social network with only flat interactions:
Trusted Boundary (Who can see this?)
Relevance/Meaning (Why am I seeing this?)

For example, Table 2 below describes some sample interactions for the users in the contextual social network outlined in graphical representation 225.

When a user u11 (230) creates an interaction with a boundary definition of “1”, or one level of context, the user who can participate in that interaction is u12 (235). For user u12 (235), the relevance/meaning is represented by the Context “C1” (240). For example if the user u11 (230) creates a message to be shared into the context C1 (240), the trusted boundary definition decides who can see that message, and the receivers of the message can know why they are seeing that message (e.g., “they are associated with the same context as the user who created that message”). In some embodiments, the information providing context of the message is prominently presented to the user when the message is received and thus enhances the message by providing the contextual association (e.g., reason for the message).

When the user u11 (230) creates an interaction with a boundary definition of “2”, or two levels of context, the users who can participate in this interaction are u12 (235), u31, u32, u41, u42. For example, when a user u11 (235) shares a photograph with the trusted boundary definition of two, the users who can see this photograph are associated with contexts that are in turn associated with the context C1 (240) user u11 (230) is associated with, and their Relevance/Meaning describes the contextual association path. For example user u31 is able to see this photograph because of the association with C3 which is in turn associated with C1 (240). Also the Relevance/Meaning that user u31 sees attached to that photograph can be derived from “C3←C1”, which represents the context path for the contextual relationship (e.g., contextual association path).

TABLE 2
Interactions in a contextual social network

| | Boundary | Users in Trusted | |
|---|---|---|---|
| User | Definition | Boundary | Relevance/Meaning |
| u11 | 1, C1 | u12 | u12: C1 |
| u11 | 2, C1, C3, C4 | u12, u31, u32, | u12: C1 |
| | | u41, u42 | u31: C3←C1 |
| | | | u32: C3←C1 |
| | | | u41: C4←C1 |
| | | | u42: C4←C1 |

There also exist possible extensions to the basic Context Model disclosed above. The following “hard” rules are according to one example embodiment and could be varied in other embodiments without departing from the scope of this disclosure:

Roles (e.g., Special Relationships with Contexts).

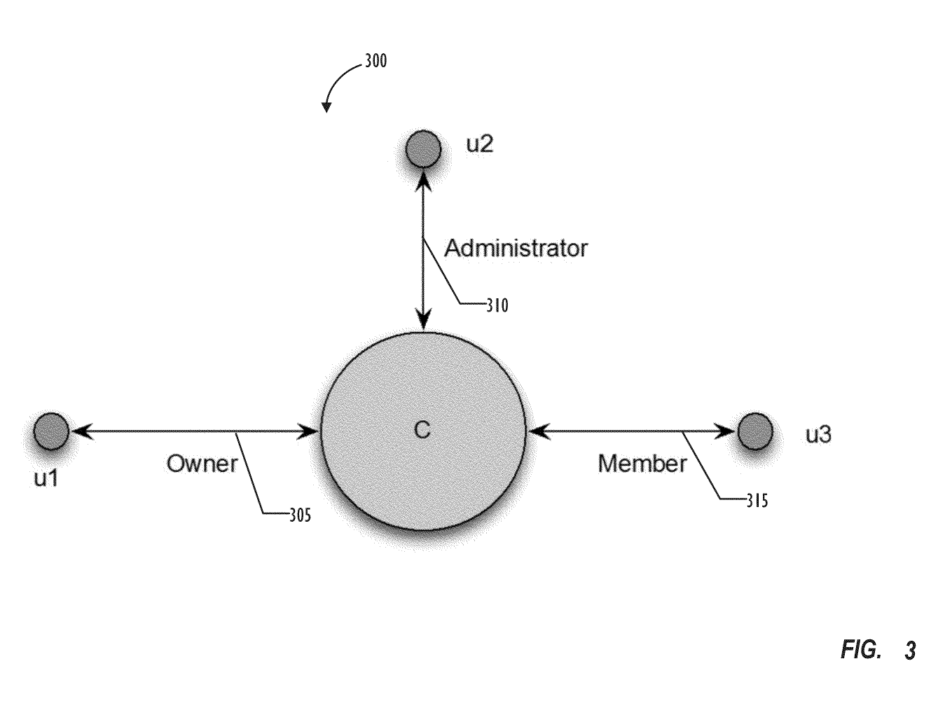

Contexts are always associated with at least one user (i.e., there are no “orphaned” contexts). There are at least three basic types of users who may have a special role relationship with a given context. These are illustrated graphically in FIG. 3 graph 300. First there can be an “Owner” relationship (305) where the context can have a single owner that has permissions to create/update/delete all interactions and memberships associated with the context and its relations with other contexts. The owner is the only role that can delete a context, or transfer the ownership of the context to another user. Second, there can be an “Administrator” relationship (310) where the administrator may create/update/delete all interactions and memberships associated with the context and its relations with other contexts. The administrator cannot delete the context or transfer the ownership of the context. Third, there can be a “Member” relationship (315) where the member of a context may create interactions associated with the context, and may update/delete them based on the context policies. A member does not have the rights to manage the memberships or the association of the context with other contexts. Throughout this document a member of a context under the “normal” member relationship is also referred to as a “user associated with” the context.

Membership Types

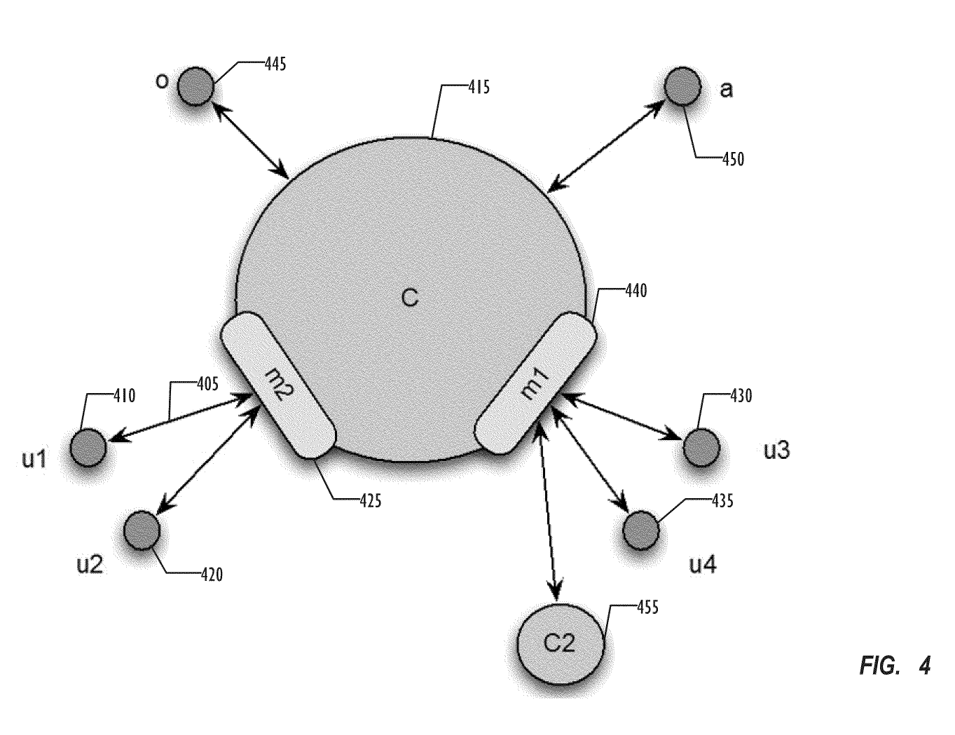

The members of a Context may be further grouped or partitioned by member types. This can provide a further level of managing trust and connectivity with respect to a context. For example in FIG. 4, the interaction (405) created by user u1 (410) in the Context C (415) may be visible only to user u2 (420), because both u1 (410) and u2 (420) are members of Context C (415) via membership type m2 (440). Interaction (405) will not be visible to users u3 (430) and u4 (435) because they are associated with the Context C (415) through membership type m1 (440). However all interactions are visible to the owner “o” (445) and administrator “a” (450) per the “Role” policy discussed above. Because a context may be associated with other contexts, a membership type may also be used to facilitate how one context is associated with another context. For example, in FIG. 4, C2 (455) is associated with C (415) through the membership type m1 (440). This can allow users (not shown) who are associated with C2 (455) to participate in interactions of C2 (455) that are limited to membership type m1 (440). For example, the owner o (455) of C (415) may want to post a message that is limited to all members who are connected to C (415) through m1 (440). This will be available now to members of C2 (455), who may then respond to it, or participate in that interaction in another manner.

Associations

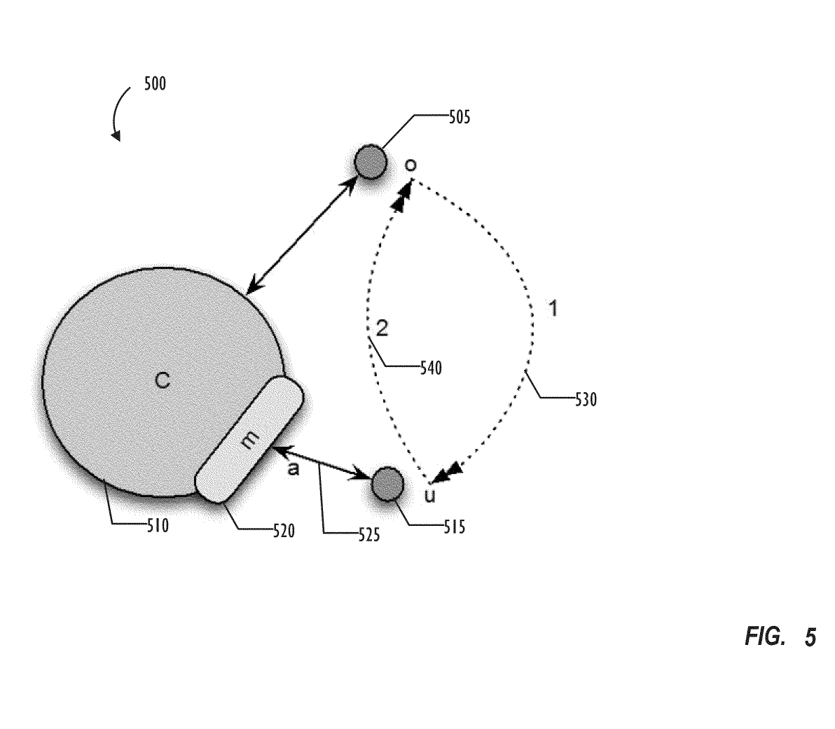

The association of a user with a context or that of a context with another context is typically done through invitations. For example in FIG. 5 diagram 500, the owner “o” (505) of a context “C” (510) invites a user “u” (515) to be associated with C (510) with membership type “m” (520) (step-1 530). When a user “u” (515) accepts (Step-2 540), the association “a” (525) between user u (515) and context C (510) can be created.

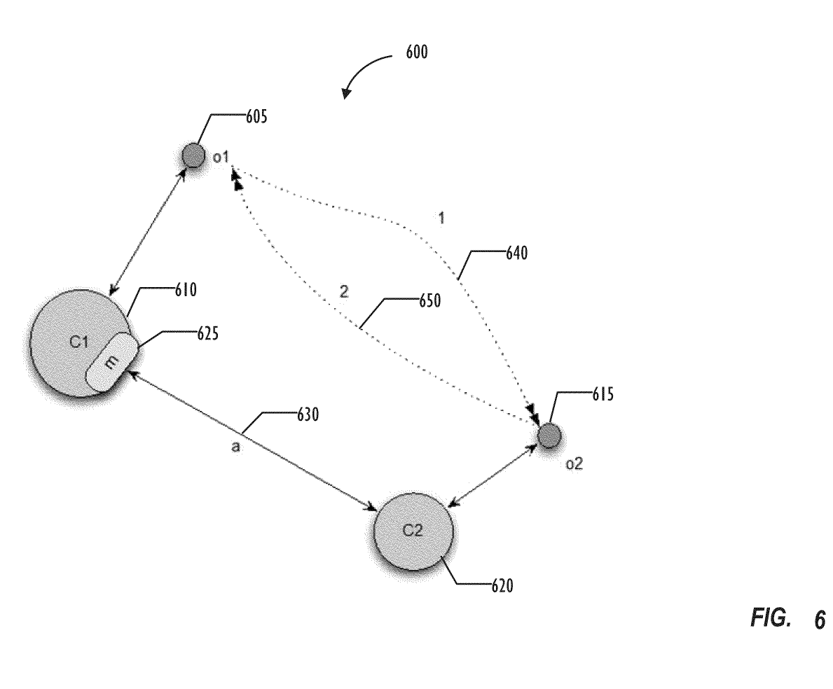

A similar method can be adopted to create an association between contexts. For example in FIG. 6 diagram 600, the owner “o1” (605) of a context “C1” (610) invites owner “o2” (615) of another context “C2” (620), for C2 (620) to be associated with C1 (610) through membership type m (Step-1 640). When o2 (615) accepts the invitation, then an association “a” (630) between C2 (620) and C1 (610) can be created (Step-2 650).

Network Boundary

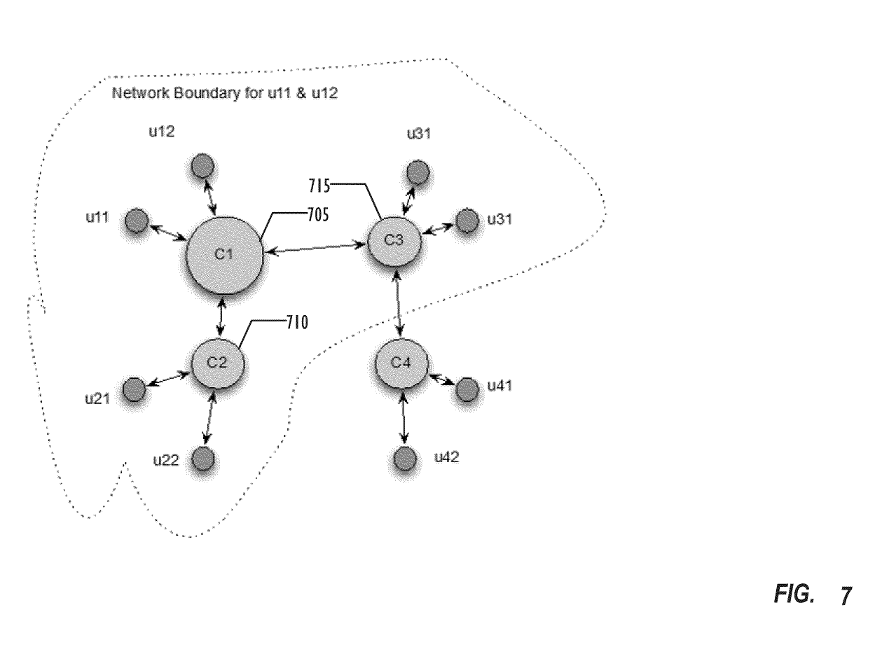

In a contextual network, the definition of “a network” for a user could be defined at the level of a set of contexts, and based on the role of a user for those context(s). For example, in FIG. 7, contexts C1 (705), C2 (710), and C3 (715), all have policies that allow all their memberships to be visible to two levels of association. So the network for user u11 consists of users (u12, u21, u22, u31 & u32).

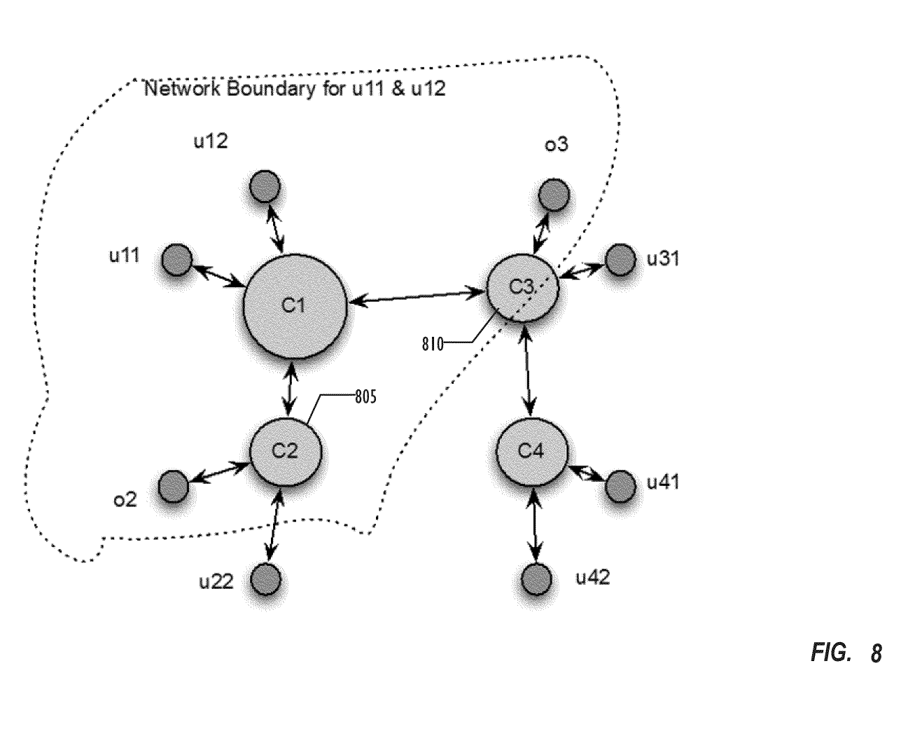

In FIG. 8, contexts C2 (805) and C3 (810) have a more restrictive policy—that only their Owners are visible to the second level of context associations. In this case the network definition of u11 will be (u12, O2, and o3), where o2 is the owner of the context C2 (805) and o3 is the owner of the context C3 (810). Similarly, the network definition of U12 would be (u11, o2, and o3).

Network all Boundary

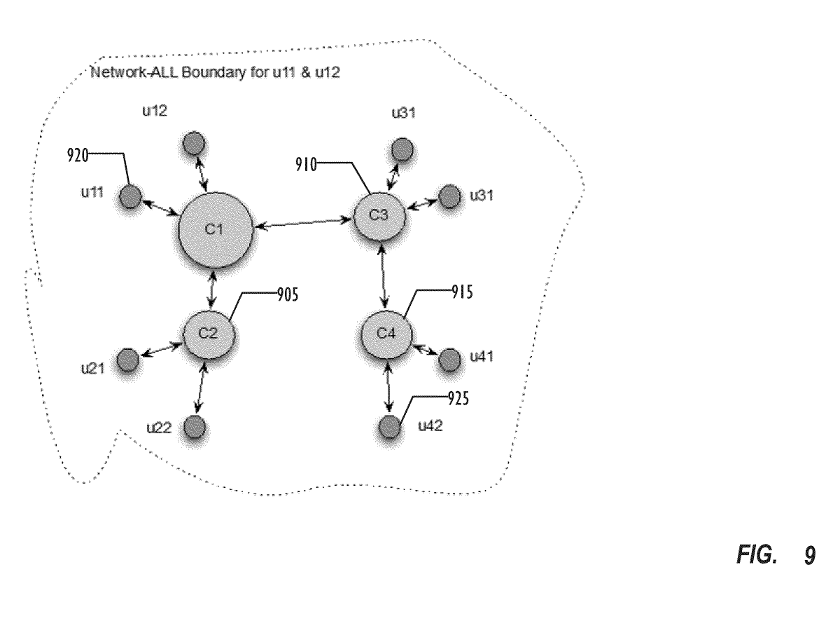

A special type of network boundary may be made available for a special type of interaction that allows interactions to be visible across connected contexts without any limitation to the depth of association (e.g., any number of levels can exist between the connected contexts). These may also be controlled using a policy attribute of a context. For example in FIG. 9 contexts C2 (905), C3 (910), and C4 (915) each have policies that allow interactions marked as “Networked-ALL” to be passed to all their members (users and contexts). In this case an interaction created by user u11 (920) marked “Network-ALL” will be visible to u42 (925) (associated with Context C4 915), because contexts C3 (910) and C4 (915) both have policies that allow Network-ALL interactions to be passed on without consideration of the depth of context associations.

Context Types

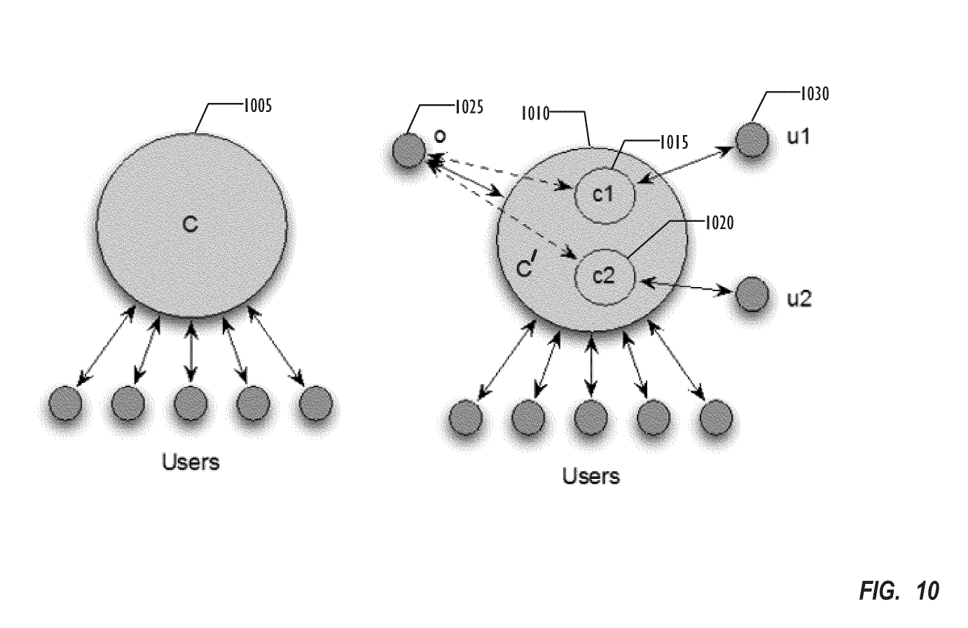

Contexts may be classified based on whether they contain sub-Contexts or not. For example in FIG. 10, the Context C (1005) is a simple context which does not contain sub-Contexts. FIG. 10 also shows a context C′ (1010) that contains two sub-contexts c1 (1015) and c2 (1020). Sub-Contexts can derive their ownerships and administrators from their parent-context. For example in FIG. 10, “o” (1025) is the owner of the context C′ (1010), and hence also the owner of sub-contexts c1 (1015) and c2 (1020). Memberships may also be inherited by the sub-contexts. For example all users of C′ (1010) are also users of sub-contexts c1 (1015) and c2 (1020). However a user specific to sub-context c1 (for example, u1 (1030)) is not a member of c2 (1020). Further refinements of these models are possible to allow for flexibility in the construction of a contextual social network targeted at specific applications.

Context Policies

Contexts can have several policies associated with them.

Basic policies such as:
Only the owner can delete the context; and
Only the owner can transfer the ownership of the context.
   Membership policies such as:
Allow other contexts to associate or only users.
   Network boundaries can be defined at the context level such as:
Allow visibility to memberships based on network depth;
Allow visibility to memberships based on membership types; and
Allow Network-All visibilities.

The following sections illustrate example Applications of a Contextual Social Network.

Families and Community Around Children

This use-case example for a contextual network model describes how parents, families and communities around children could come together will well defined trust boundaries to share privately and schedule/coordinate to reduce the chaos in their lives and focus on what's important—raising children.

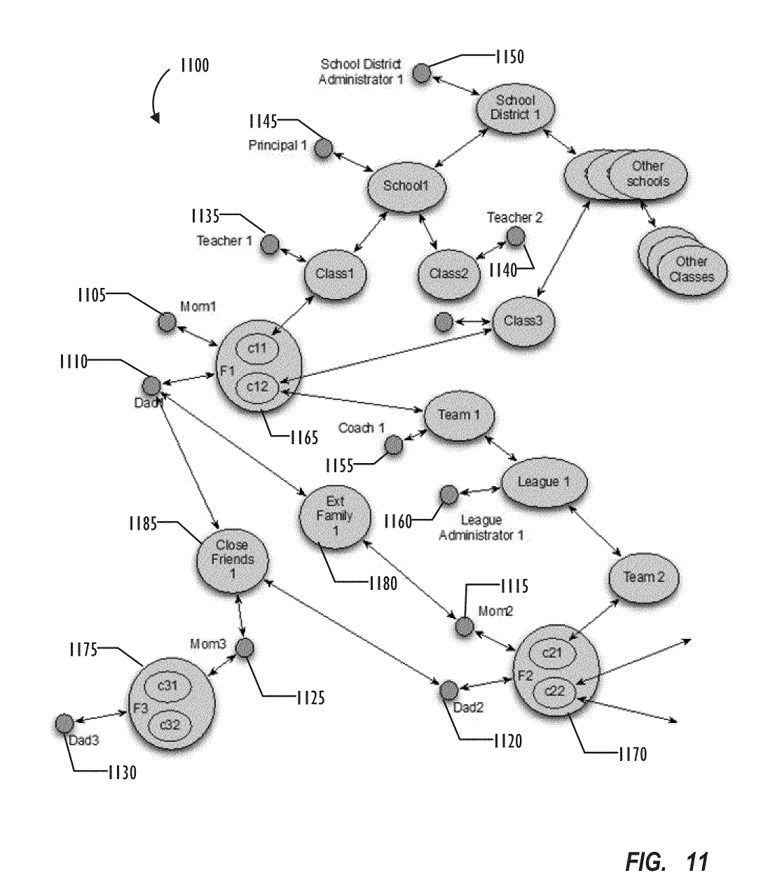

An example model 1100 for such a network is shown in FIG. 11. The number of users shown in this network is limited for simplicity, and the network is likely to be much larger in a real world example consisting of many schools, leagues, classes, teams, families, etc.

Some highlights of this example network 1100 include:

Users:
Three sets of parents—Mom1 (1105), Dad1 (1110), Mom2 (1115), Dad2 (1120), Mom3 (1125), and Dad3 (1130).
Teacher1 (1135) & Teacher 2 (1140)—school teachers.
Principal 1 (1145)—principal of a school.
School District Administrator 1 (1150)—manages a school district.
Coach 1 (1155)—coaches a team.
League Administrator 1 (1160)—manages a league with multiple teams.
   The following are the “Contexts” in example network 1100:
Families—F1 (1165), F2 (1170), and F3 (1175).
Children belonging to these families—c11, c12, c21, c22, c31, and c32.
An extended family (1180)—“Ext Family 1.”
A Close Friends context (1185)—“Close Friends 1.”
Classes—Class1, Class2, Class3 and “other classes.”
Teams—Team1, and Team2.
School—School 1 and “other schools.”
League—League 1
School District—School District 1
Sports League—League 1

Trusted boundary examples relative to example network 1100.

A picture of c11 shared by Dad1 (1110) with a boundary definition of one would be shared with Mom1 1105 (via context F1 (1165)), Mom2 1115 (via context Ext Family 1 (1180)), Mom3 1135 (via context Close Friends 1 (1185)). Teacher 1 (1135) could share a lesson plan with Mom1 (1105) via the context path (c11←Class1). Mom1 (1105) could then comment on the lesson plan within the context of family F1 (1165). A message to all principals of School District 1 could be sent by School District Administrator 1 (1150).

Relevance/meaning examples relative to example network 1100.

Mom1 (1105) can see a photo of c11 posted by Teacher 1 (1135) in the Class 1 context, with the context path “c11←Class1” providing relevance/meaning. Dad1 (1110) can see an event scheduled by the School District Administrator 1 (1150) with the context path “c11←Class1←School1←School District1.” Dad2 (1120) could receive a special message about c21 from League Administrator 1 (1160) that carries the context path “c21←Team1League1.” When the same message is re-shared by Dad2 (1120) with Dad1 (1110), Dad1 (1110) sees that message with a context path “Close Friends1” (1185).

Transience examples relative to example network 1100.

When c11 moves from Class 1 to Class 3, the connection with other parents of Class1, Teacher1 and Principal1(School1) can be automatically removed and new connections with Class 3, and the new School can be automatically established without the need to “unfriend” or remove all the individual transient associations in c11's network.

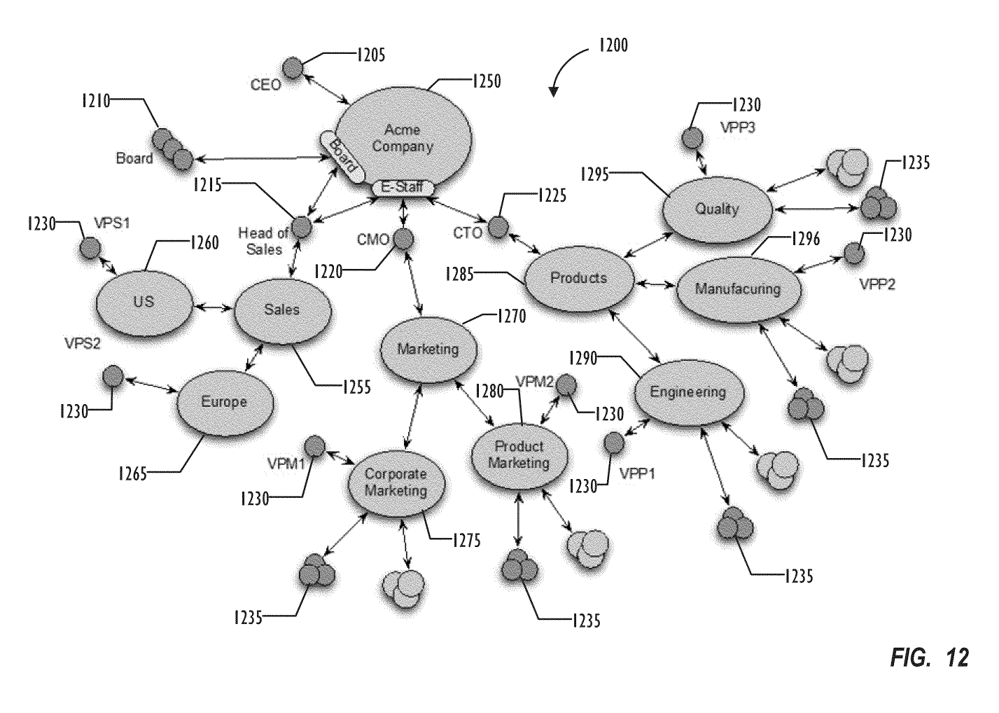

Enterprise organizations could also benefit by using a contextual social network that mirrors the organizational structure. FIG. 12 shows an example network 1200 of the contextual social network applied for an example enterprise. As enterprises evolve from outdated communication models centered around email and file-sharing, applying social collaboration models that have trusted boundaries and relevance/meaning in interactions can become increasingly important for productivity and efficiency.

A typical business organization is organized by key functions. This example shows how such a functionally organized enterprise may be setup using a contextual social network. The network shown in this example can be extended all the way down to each employee of the enterprise, each connected locally to the respective contexts but also connected across the enterprise through the context network.

Users in this example network include:
The CEO (1205).
The Board members (1210).
The heads of the various functions—Head of Sales (1215), Chief Marketing Officer (CMO (1220)), and Chief Technical Officer (CTO (1225)) of Products.
The next level of executives (e.g., Vice Presidents) for each of these functions 1230.
etc. (e.g., employees 1235 and other lower level contexts)
   The following are some of the “Contexts” in this sample network
The company 1250.
Sales (1255), Sales-US (1260), and Sales-Europe (1265).
Marketing (1270), Corporate Marketing (1275), and Product Marketing (1280).
Products (1285), Engineering (1290), Quality (1295), and Manufacturing (1296).

Trusted boundary examples relative to example network 1200.

The board consists of the CEO (1205), Head of Sales (1215), and other board members (1210). The Head of Sales 1215 and other board members are connected to the “The Company” context (1250) via the member type “Board”. The CEO (1205) is a member of the member type “Board” in this example because he is the owner of the company context 1250. All interactions by members of the board in this example network are in the context of the company, but may reside in the trusted boundary defined by the membership type board because of their membership association (and the CEO's (1205) context ownership).

When the CEO (1205) initiates a message/post for that he wants to send to all employees of the company, he can mark the interaction as “Network-ALL”. All the contexts in the example network 1200 are configured by their policy to pass the Network-ALL interactions, so these interactions are available to all employees. When the Head of Sales (1215) would like to discuss the monthly sales for US he can create a message in the “Sales” context (1255) for the members of the context “US” (1260).

Relevance/meaning examples with respect to example network 1200.

Employees all receive the message from CEO 1205 and see the message from the CEO relative to the network path traversed via the levels of contexts. This path information can provide significant relevance/meaning for the message. All US sales representatives can see the message from Head of Sales (1215) while the European sales team will not see that same message.

Transience examples relative to example network 1200.

When/if VPS1 of US changes jobs with VPS2 of Europe only those two connections need to be updated and the contextual network model retains its meaning.

Network of contexts relative to example network 1200.

The disclosed contextual social network provides a network of contexts, instead of just users. This can allow the ability to apply the platform for any vertical application and make the experience meaningful/relevant.

Examples of one possible user interface via screen shot samples:

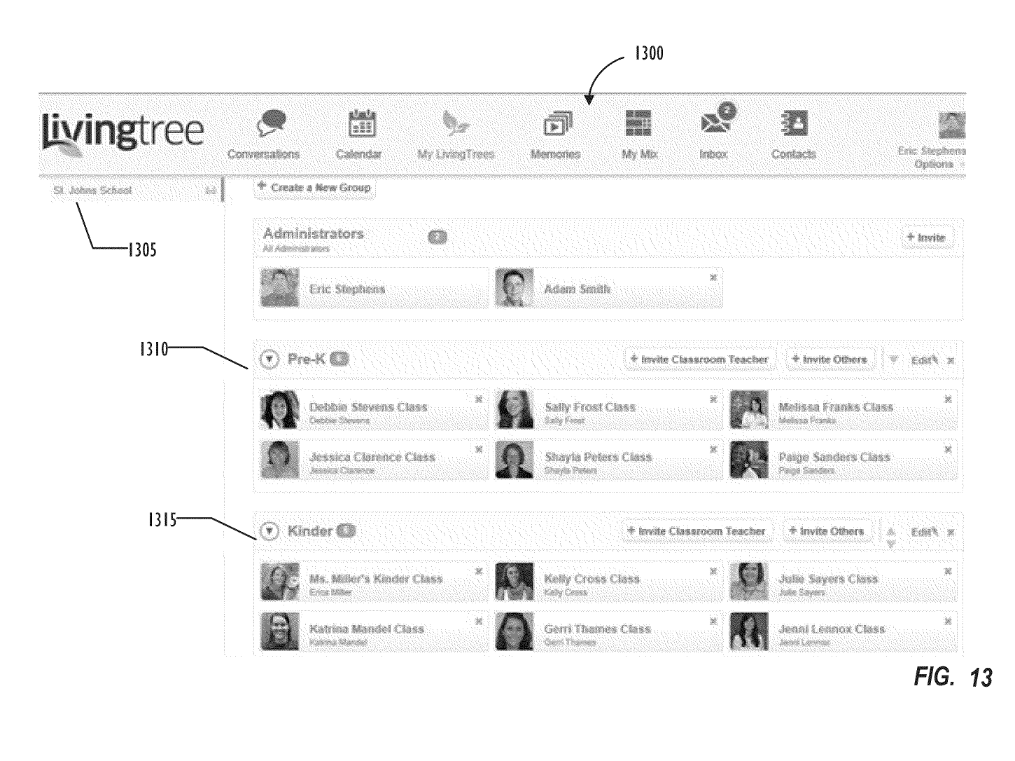

A network of school, classes, and children built in the way communications flows with the ability to attach children to classes and snap multiple classes into a single organization. See FIG. 13 screenshot 1300. The school administration (superintendent and principal here) have a network of classes by grade level. Eric Stephens is the Principal (OWNER) of the school St. John's School (CONTEXT) 1305, and has his School Organized by grades Pre-K 1310, Kinder 1315 etc. (MEMBER GROUPS).

The respective teachers/classes associated with his school by their grade specific member groups. For example Erica Miller, a Kinder teacher is the OWNER of a class Ms. Miller's Kinder Class (CONTEXT) and is associated to St. John's School (CONTEXT) via the member group Kinder.

Each class has a network of children (and parents through their children) connected to the teacher and ultimately the school. Here, the teacher is the class administrator and the school administrator has been added as second administrator or assistant giving them administrative privileges for managing the class connections.

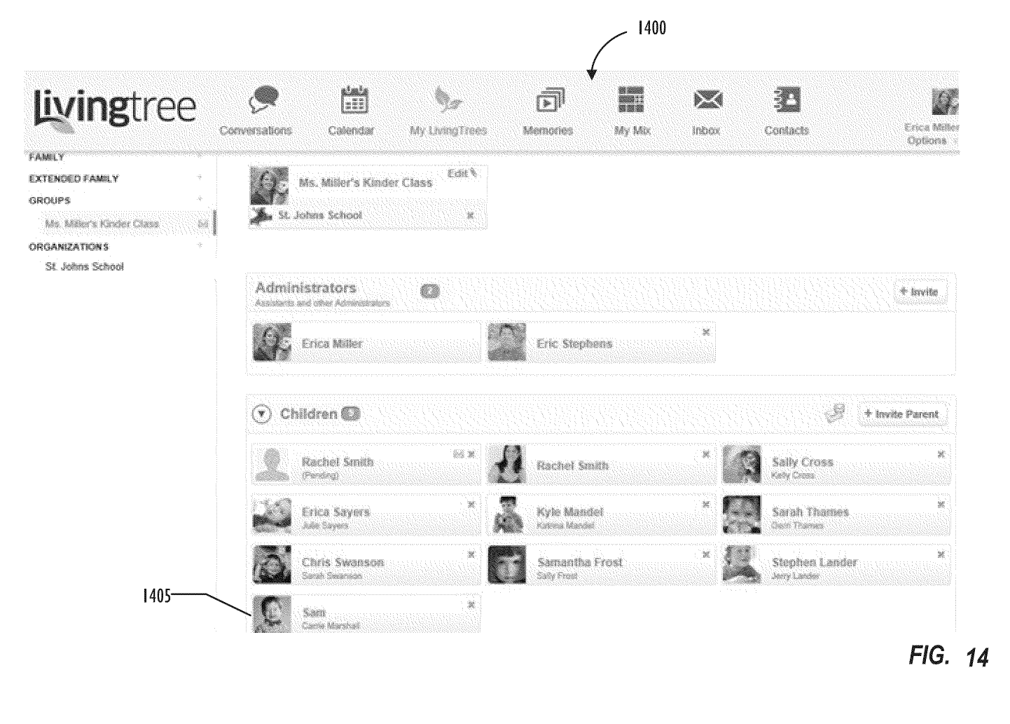

FIG. 14 screenshot 1400 shows Erica Miller (OWNER) of a class, Ms. Miller's Kinder Class (CONTEXT) associated with St. John's School (another CONTEXT). The parents of the various children in the class are associated with the class through the member group called “Children”. Here for example, Carrie Marshall who is the mother of Sam 1405 is associated with Ms. Miller's Kinder Class through the member group “Children”.

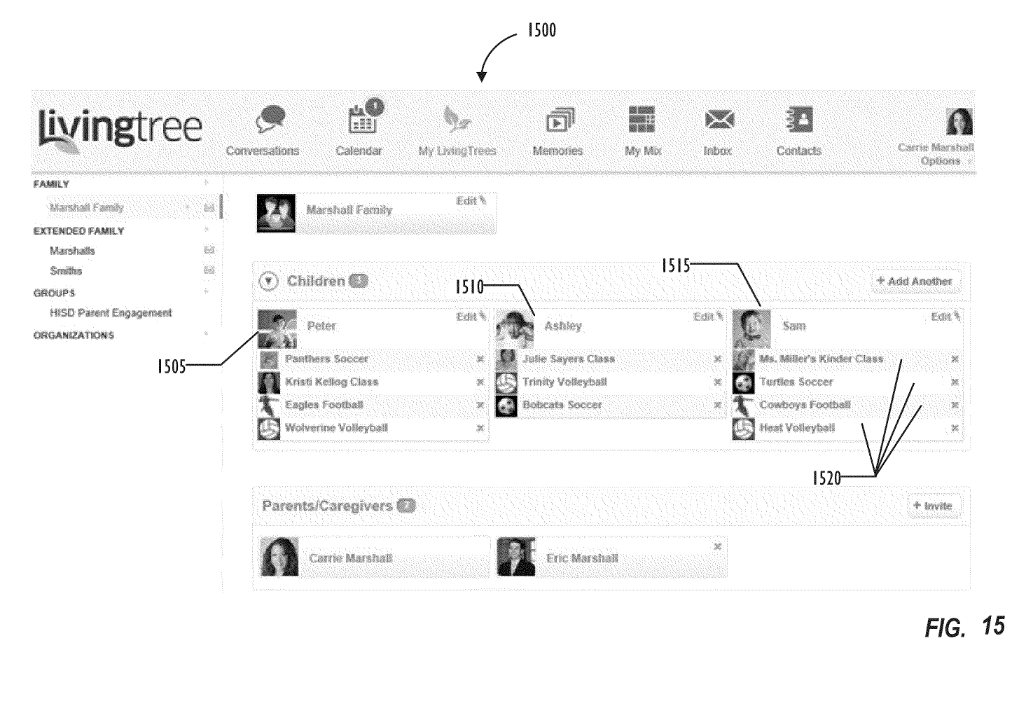

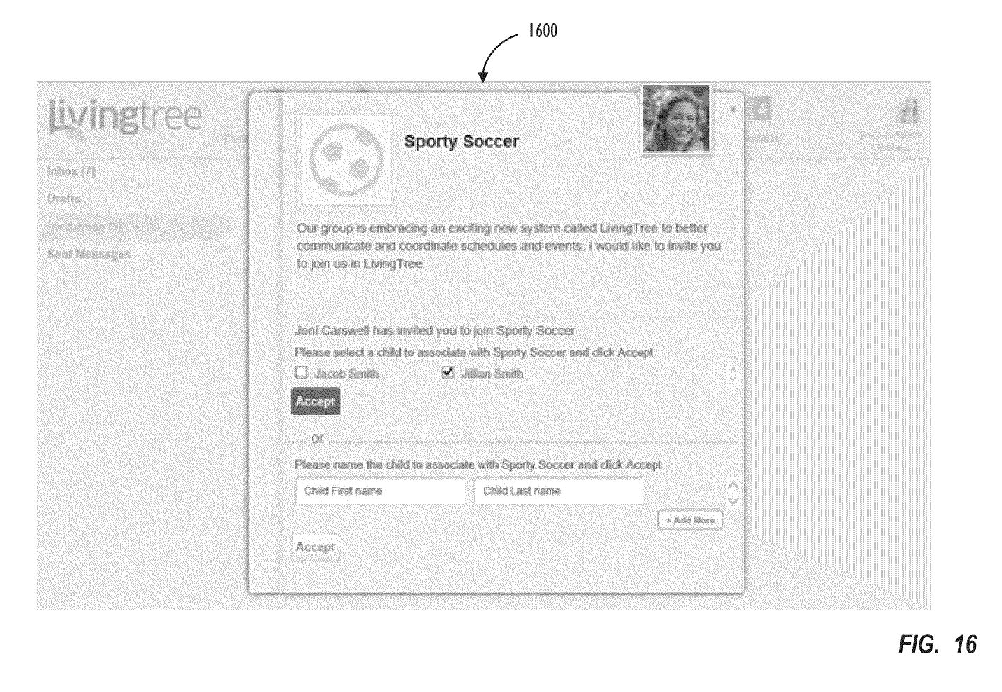

Parents are connected to the school in the context of their child's class. For example in FIG. 15 screenshot 1500, Carrie Marshall, mom, is the OWNER of the CONTEXT “Marshall Family”. Eric Marshall, dad, is an ADMINISTRATOR of the Marshall Family Context. There are three children (SUB-CONTEXTS, as described with respect to FIG. 10)—Peter 1505, Ashley 1510, and Sam 1515. Sam 1515 is associated with Ms. Miller's Kinder Class (as in FIG. 14 above), and with three other contexts—Turtles Soccer, Cowboys Football, and Heat Volleyball (see 1520). Please note that each of these contexts (teams) may be associated with other contexts (example a League). The association of a context and users can be formed through invitations and accepts (outlined described above with respect to FIG. 6). For example, in FIG. 16 screenshot 1600 shows an interface where a parent could accept an invite into a team (“Sporty Soccer”) and possibly into the league for that team, both relationships are in the context of the selected children.

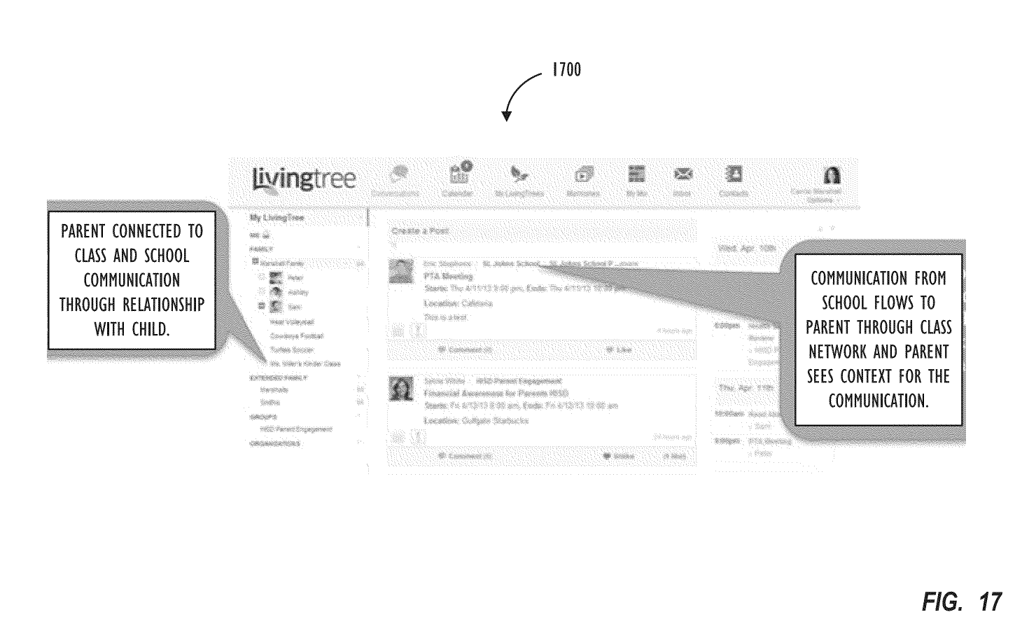

The network of contacts can be used for communications, interactions, scheduling and messaging within the network that comes together around children (parents, teachers, coaches, principals, league administrators, etc.) from children up through the respective organizations in the context of the child, class, team and ultimately the school/league. Each user is able to see their connection and the context of the communication, event, etc. The parent is able to see class/team/group connections for each child—a contextual network. See FIG. 17 screenshot 1700.

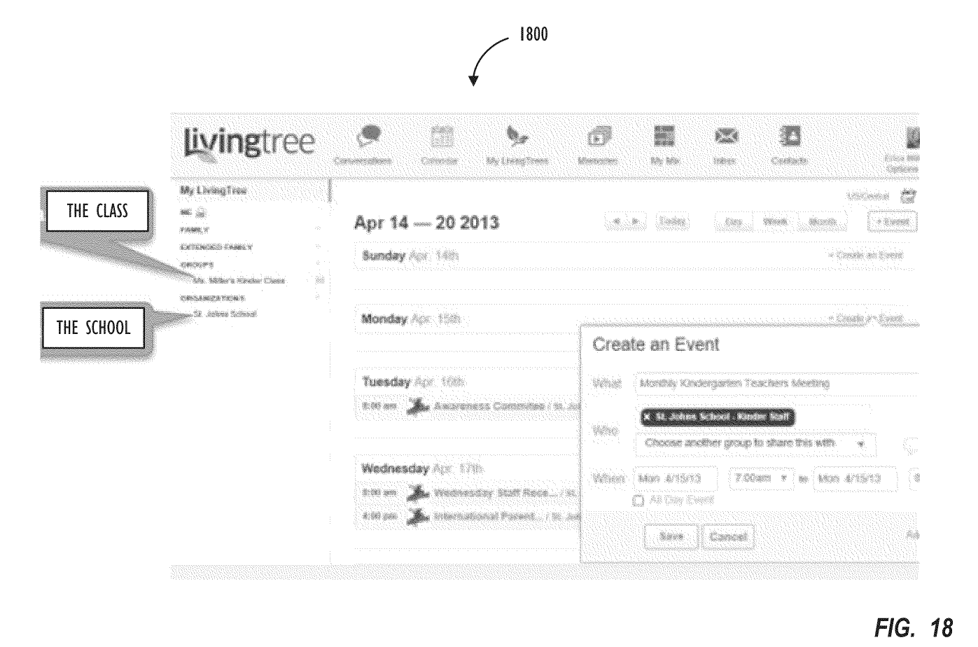

The teacher sees the group she owns (her class) and the organization to which her class belongs (the school). She is able to communicate and create events in the context of either or both. See FIG. 18 screenshot 1800.

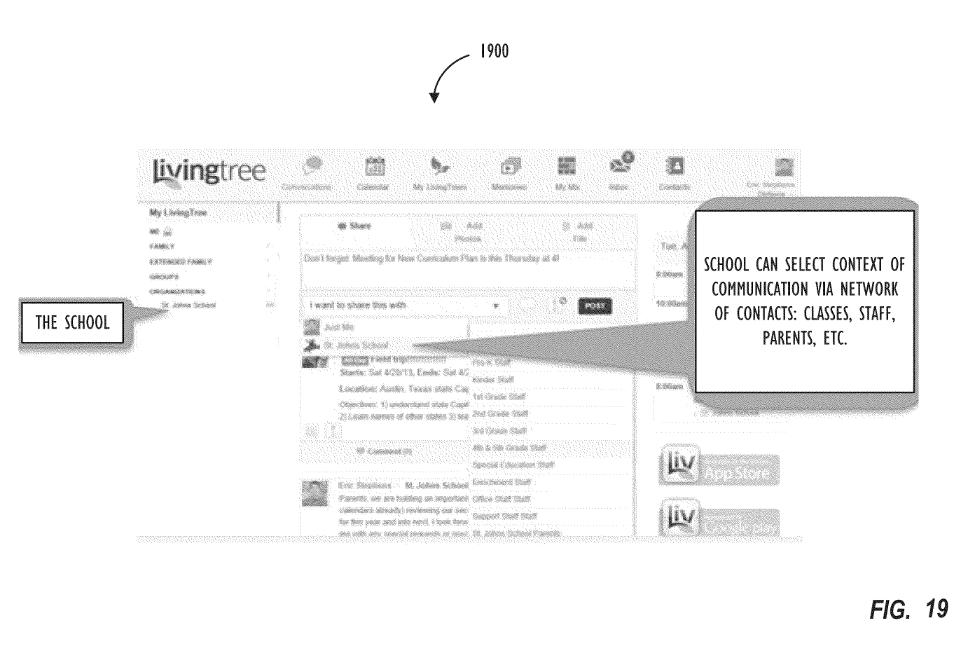

The school administrator is connected to each class and able to communicate through to the parents based on the contextual network. See FIG. 19 screenshot 1900.

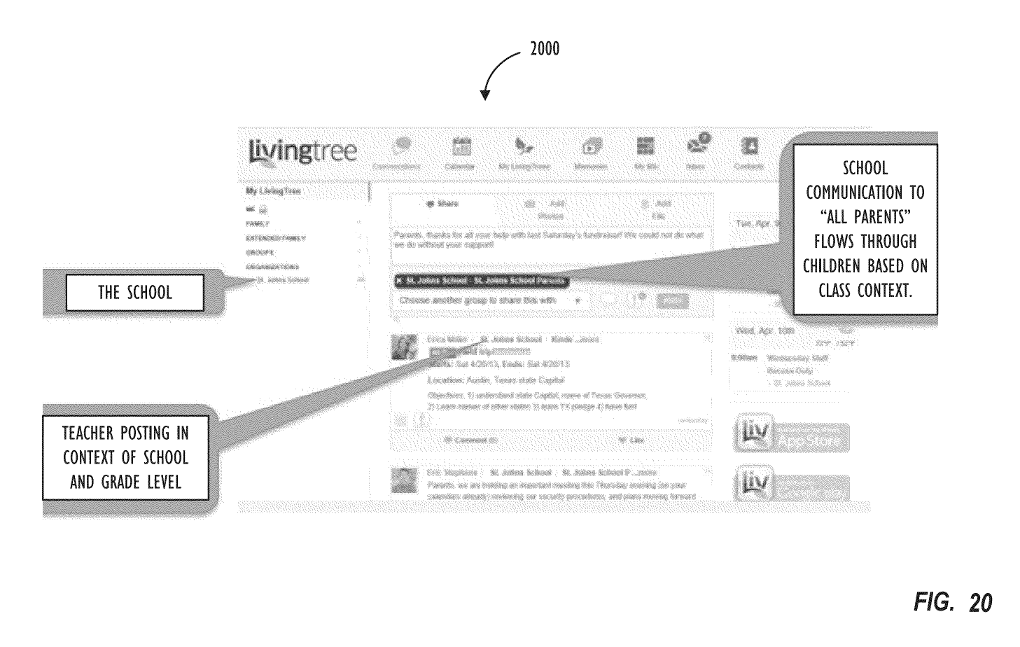

Communication stream carried out through network of contacts and contextual relevance. See FIG. 20 screenshot 2000.

Trusted Boundary

The disclosed contextual social network provides an ability to create trusted boundaries for its users in a natural way as their application demands, and in a way that mimics the real world interactions in these example verticals.

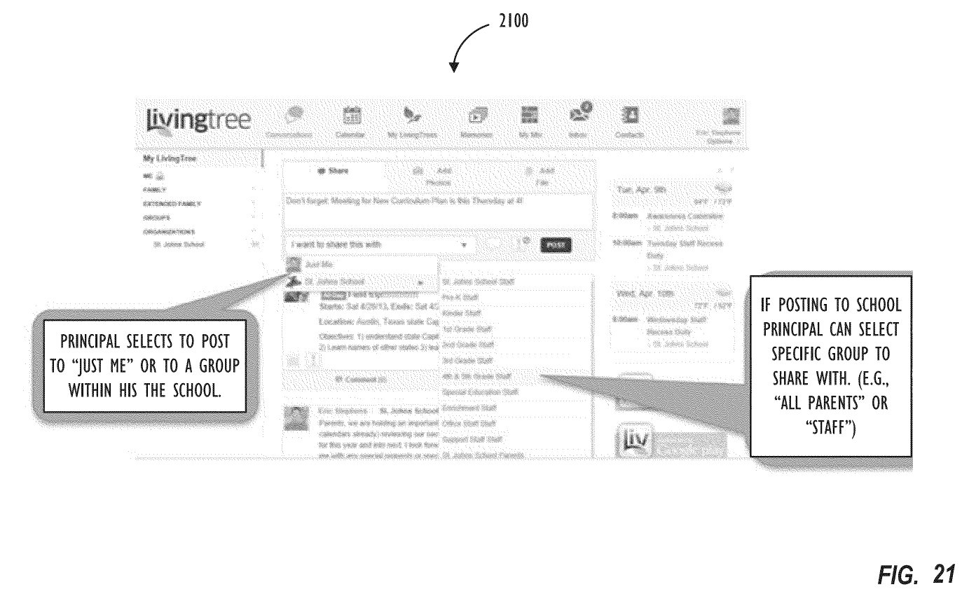

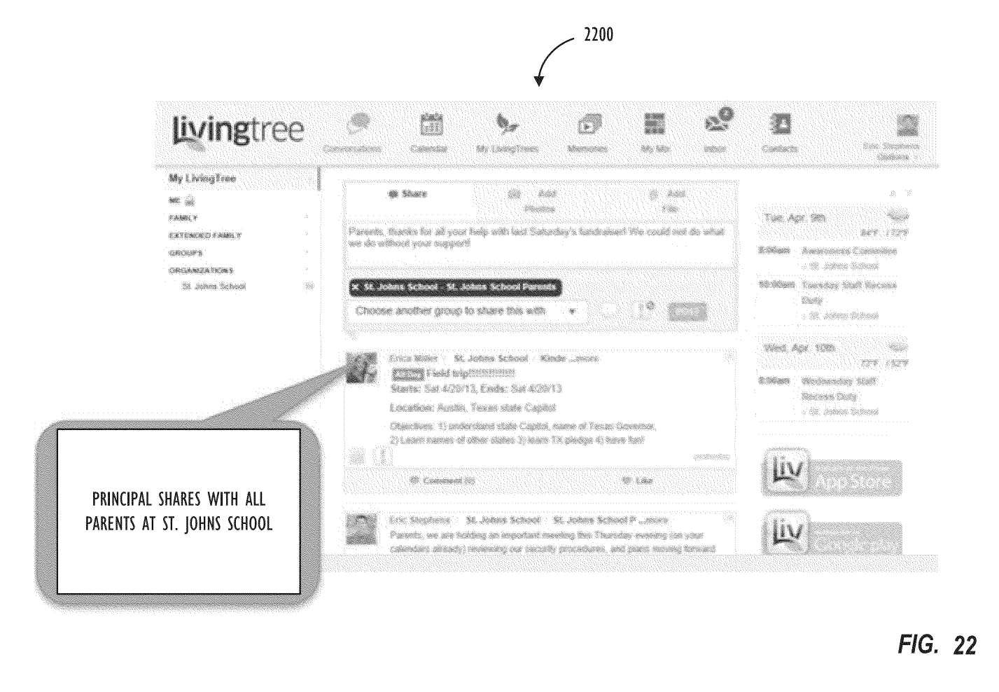

In FIG. 21, screenshot 2100 illustrates that the principal is able to interact with other users in his contextual network across trusted boundaries very easily. For example, when posting a message to a specific groups of users exposed in the user interface via a drop down menu. Using the same option the principal can also communicate with more than one set of users by multi-selecting the options in the drop down (FIG. 22 screenshot 2200).

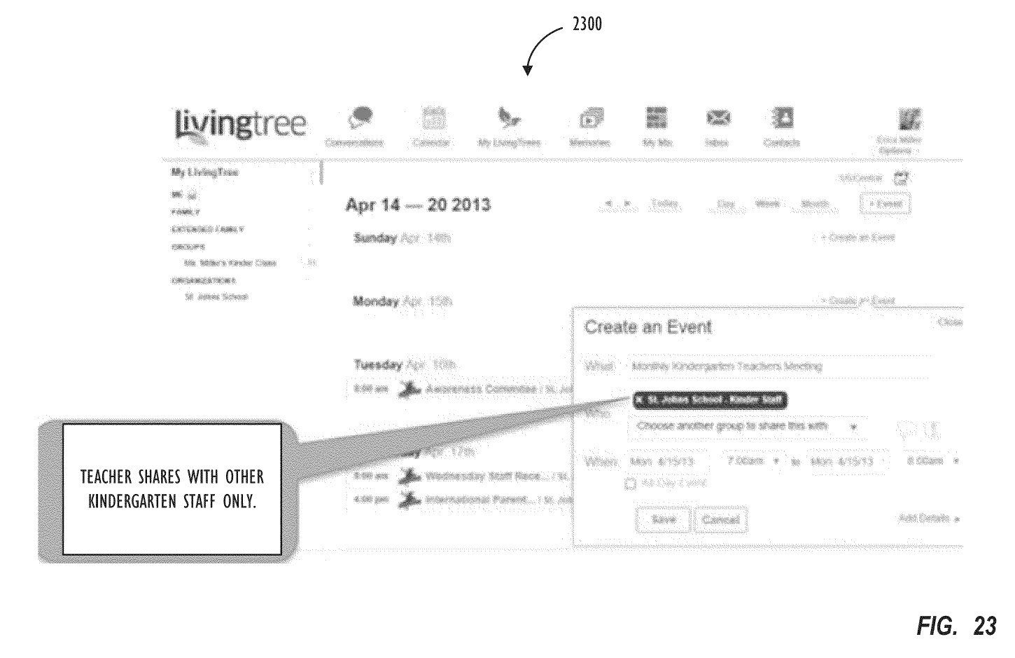

As a teacher within a school like St. Johns, there are options to communicate (Posts/Events) in the context of their class, or with a group of peers. For example, FIG. 23 screenshot 2300 illustrates a group event. Only the members in the Kinder Staff group will be able to see this event. All the teachers of Kinder classes are associated with St. Johns through the Kinder Staff Member group and this forms a trusted boundary.

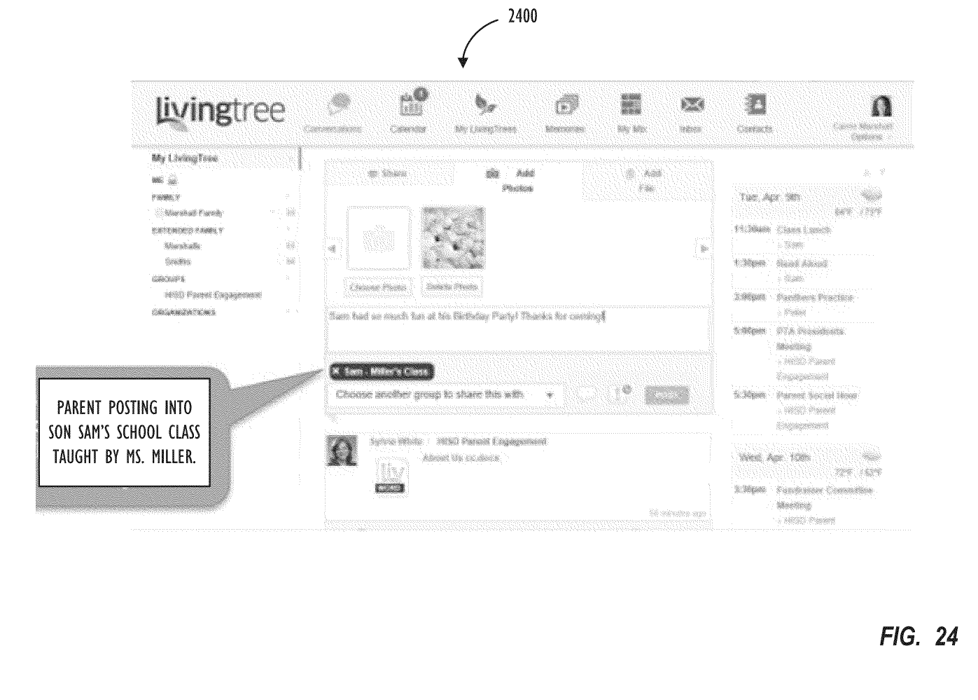

As a Parent, there are similar options to communicate (Posts/Events) with your immediate and extended families, as well as within the context of a group that their child is connected to. This is illustrated in FIG. 24 screenshot 2400.

Relevance/Meaning

Relevance and meaning in interactions is built into the core of the platform (in contrast with trying to extract the meaning after the fact based on data mining these interactions). This also mimics the real world—the conversations we have at the work place are very different from those we have with the teacher of our child, or our doctors because the context is different. We don't try to derive the meaning based on the content of these conversations, but because of the context in which these interactions take place (school, doctor's office, workplace, etc.).

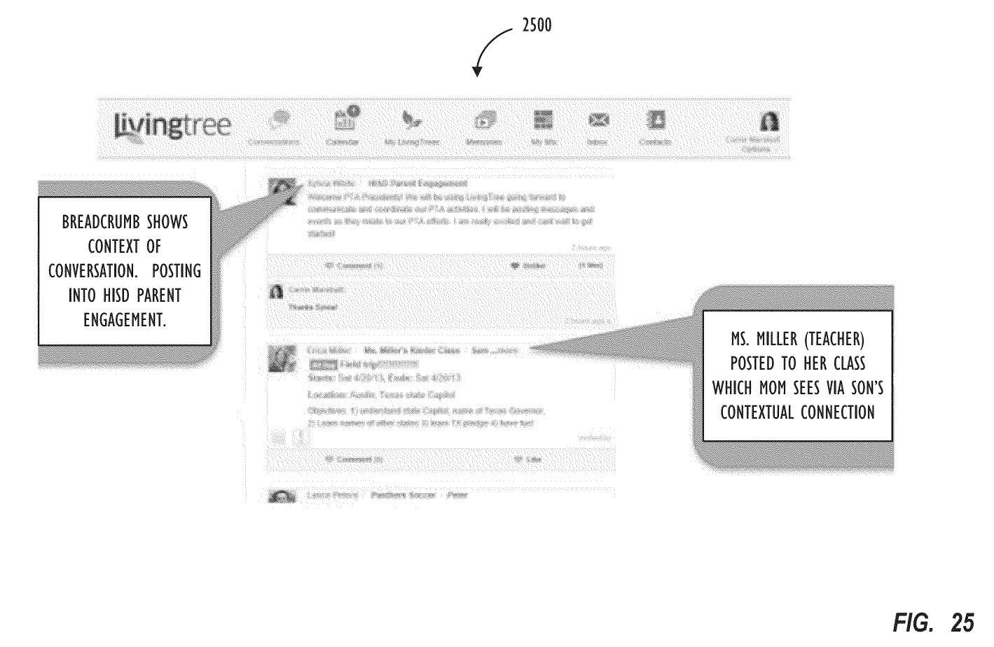

In the example illustrated in FIG. 25 screenshot 2500, a parent is interacting with the users in her contextual network. The interactions (in this case conversations or messages) carry the context with them so that the meanings of the conversations are implicit. The parent can easily determine the relevance of these interactions instead of having to figure out how they are connected with the creator of these messages.

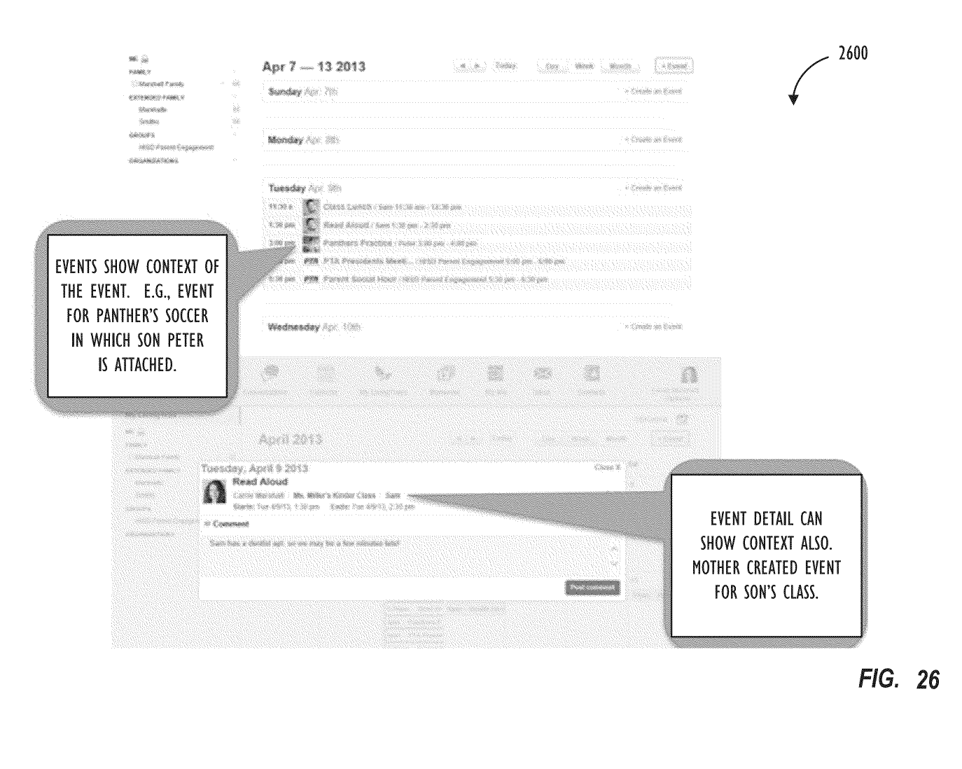

In this example, the contexts of posts are shown not only in posts on the conversations page, but within the shared calendar as well. Both of these areas share the same sharing construct, so the same aspect of context is carried through to both. This is illustrated in FIG. 26 screenshot 2600.

Transience

Relationships are formed based on contexts as opposed to being static. For example, your child's second grade friends and their parents are going to be very different from when she goes to third grade. This does not mean that you have to “friend” all her kindergarten friend's parents and then “unfriend” them when she goes to the first grade. These networks should be automatically formed based on the context (i.e. kindergarten, first grade, etc.). The disclosed contextual social network can make these transitions natural, seamless and automatic relative to any context connection updates.

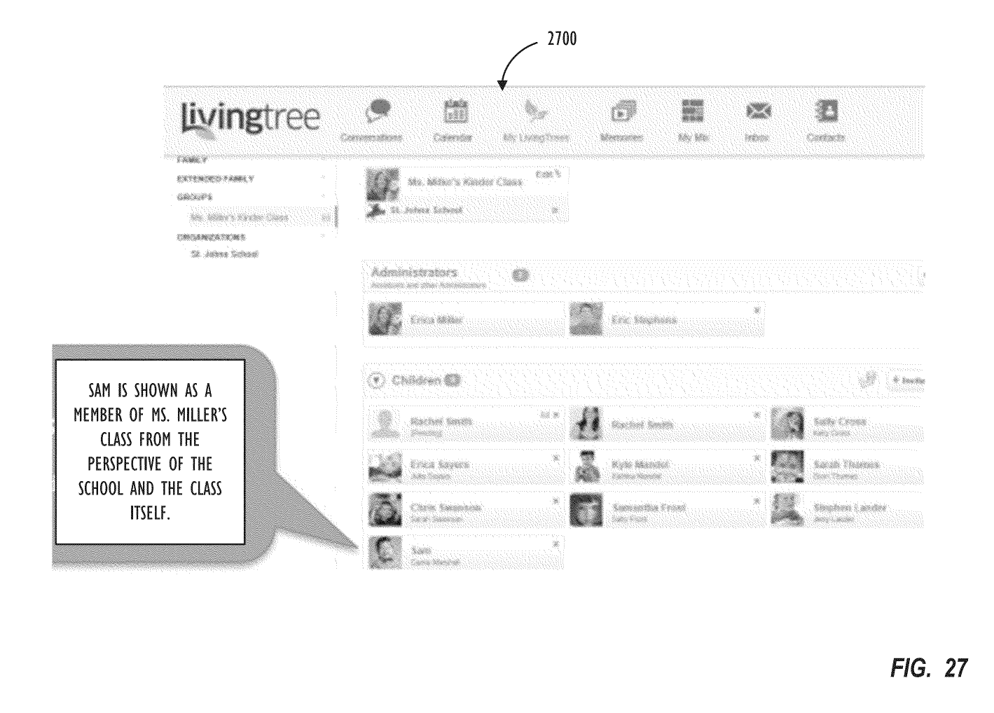

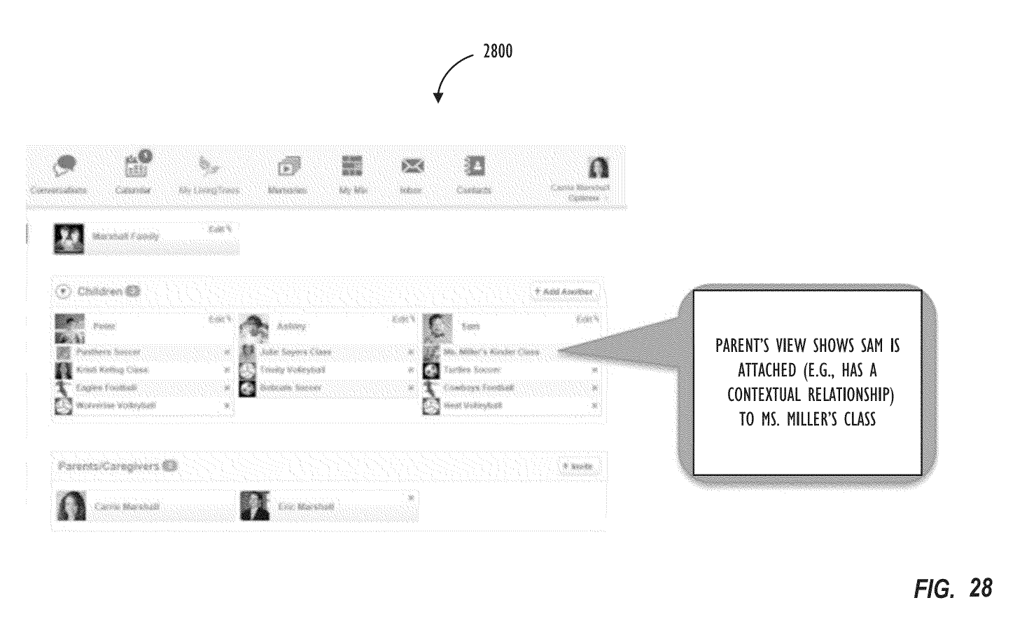

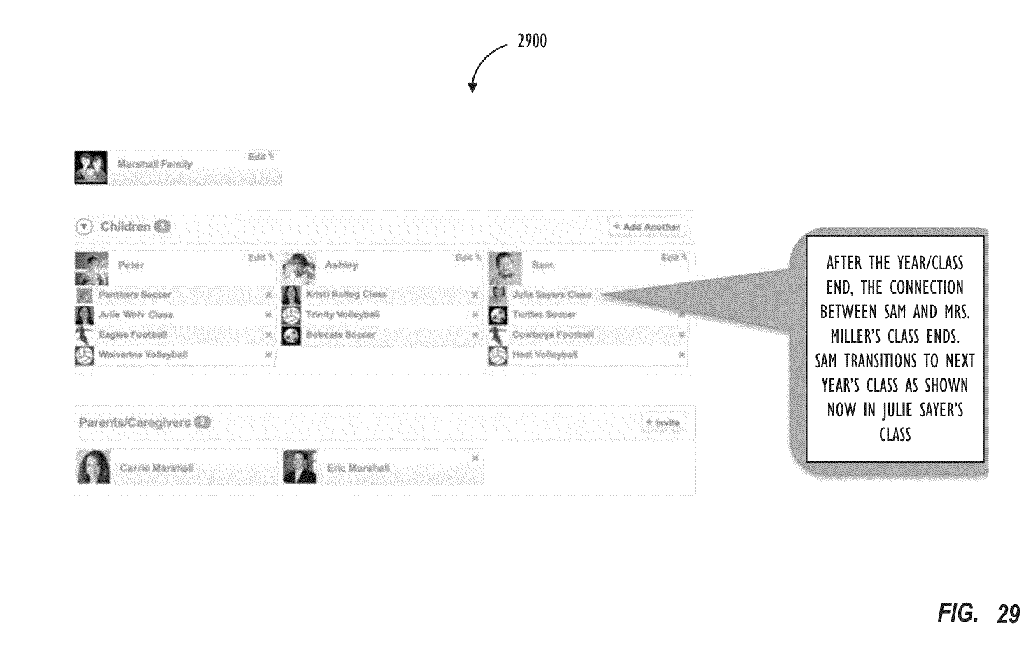

The example below illustrates how this aspect of transience manifests for a parent in the context of her son. FIG. 27 screenshot 2700 shows an example of a class (Ms. Millers), and the current members. As children change teams, classes, and youth groups, so can the network of connections they have within a contextual social network. Once a class ends, the connections with the other parents in that class can also end, and the access (from that class's context) to your child ends. In FIG. 28 screenshot 2800, Sam, who is Carrie's (mom) son is shown attached to Ms. Miller's Kinder Class. Carrie's contacts will include all the users who are connected through Ms. Miller's class (Other parents of children in that class, the teacher, the principal of the school that Ms. Miller is associated with, etc.). As connections change, they can also change under the view of each child. Only current connections will show. Once a connection to a group ends, it is no longer shown. This is illustrated in FIG. 29 screenshot 2900, where now Sam is in Julie Sayer's class, and is no longer connected with Ms. Miller's class. So the connections and other interactions can change accordingly.

The foregoing description and disclosed embodiments can be implemented on one or more computer processors specifically configured to support users in a contextual social network. Infrastructure networks can contain one or more computer networks. Computer networks can include many different types of computer networks available today such as the Internet, a corporate network or a Local Area Network (LAN). Each of these networks can contain wired or wireless devices and operate using any number of network protocols (e.g., TCP/IP). Networks are typically connected to gateways and routers, end user computers and computer servers. Also, infrastructure networks can include cellular networks for use with cellular communication. As is known in the art, cellular networks support cell phones and many other types of devices (e.g., tablet computers, PDAs or lap top computers, etc.). Obviously cell phones can be smart phones or other devices of similar capabilities.

Example processing devices for use in providing disclosed contextual social network interactions according to one embodiment include different levels of processing power relative to their functions. Servers hosting and maintaining the contextual social network may be server class hardware as opposed to an end-user interface which could be implemented in a browser or handheld computer (e.g., cell phone) for example.

What is claimed is:

1. A server computer configured to host one or more contextual social networks, the server computer comprising:
a memory; and
one or more processors communicatively coupled to the memory, wherein the memory stores instructions to configure the one or more processors to:
maintain contextual relationships of a contextual social network, the contextual relationships comprising associations between a plurality of contexts and associations between one or more users and each of the plurality of contexts;
receive a first interaction for a first context from a first user associated with the first context, the first context at a first level within the contextual social network;
receive a trusted boundary definition value associated with the first interaction, the trusted boundary definition comprising a number of context traversals allowed prior to ending propagation of the first interaction to further contexts;
initiate a propagation of the first interaction to all contexts in the contextual social network encompassed by the trusted boundary definition; and
allow users of all contexts to which the first interaction was propagated access to content of the first interaction,
wherein information pertaining to a contextual association path between the first user and each user accessing the first interaction is provided in association with the content of the first interaction.

2. The server computer system of claim 1, wherein the trusted boundary definition value equals N and the first interaction is propagated to all contexts within N−1 levels of the first level.

3. The server computer system of claim 1, wherein the trusted boundary definition value equals an indication of network-all and the first interaction is propagated to all accessible contexts within the contextual social network, the accessible contexts comprising those contexts with a traversal path to the first context via a context allowing network-all propagation.

4. The server computer system of claim 1, wherein the memory further stores instructions to configure the one or more processors to:
maintain a single role relationship between the one or more users and each context to which each of the one or more users is directly associated.

5. The server computer system of claim 4, wherein the single role relationship comprises a role selected from the group consisting of an owner relationship, an administrator relationship, and a user relationship.

6. The server computer system of claim 1, wherein the contextual social network represents an educational institution.

7. The server computer system of claim 6, wherein at least one context of the plurality of contexts represents a class and one or more users associated with the at least one context are students enrolled in the class or parents of students enrolled in the class.

8. The server computer system of claim 6, wherein at least one context of the plurality of contexts represents a class and a teacher of the class has an owner relationship with the at least one context.

9. A server computer configured to host one or more contextual social networks, the server computer comprising:
a memory; and
one or more processors communicatively coupled to the memory, wherein the memory stores instructions to configure the one or more processors to:
maintain contextual relationships of a contextual social network, the contextual relationships comprising associations between a plurality of contexts and associations between one or more users and each of the plurality of contexts, the plurality of contexts including a first context owned by a first owner and a second context owned by a second owner;
receive an indication of an invitation initiated by the first owner to directly associate the second context with the first context, wherein no prior direct association exists between the first and the second contexts;
send the invitation to the second owner;
receive an indication of acceptance of the invitation from the second owner; and
establish a direct association between the first and second contexts, wherein all members of the first and second context are automatically associated at a maximum trusted boundary definition of level two in addition to any previous association prior to the direct connection association between the first and second contexts.

10. The server computer system of claim 9, wherein the memory further stores instructions to configure the one or more processors to:
receive an indication from the first owner or second owner to disassociate the first context from direct association with the second context; and
delete the direct association between the first and second contexts, wherein all members of the first and second context are no longer connected via the deleted direct association but maintain all other associations in existence immediately prior to deleting the direct association.

11. The server computer system of claim 9, wherein the contextual social network represents an educational institution.

12. The server computer system of claim 11, wherein at least one context of the plurality of contexts represents a class and one or more users associated with the at least one context are students enrolled in the class or parents of students enrolled in the class.

13. The server computer system of claim 11, wherein at least one context of the plurality of contexts represents a class and a teacher of the class has an owner relationship with the at least one context.

14. A non-transitory computer readable medium comprising instructions stored thereon that when executed by a programmable device cause the programmable device to:
maintain contextual relationships of a contextual social network, the contextual relationships comprising associations between a plurality of contexts and associations between one or more users and each of the plurality of contexts;
receive a first interaction for a first context from a first user associated with the first context, the first context at a first level within the contextual social network;
receive a trusted boundary definition value associated with the first interaction, the trusted boundary definition comprising a number of context traversals allowed prior to ending propagation of the first interaction to further contexts;
initiate a propagation of the first interaction to all contexts in the contextual social network encompassed by the trusted boundary definition; and
allow users of all contexts to which the first interaction was propagated access to content of the first interaction,
wherein information pertaining to a contextual association path between the first user and each user accessing the first interaction is provided in association with the content of the first interaction.

15. The non-transitory computer readable medium of claim 14, wherein the trusted boundary definition value equals N and the first interaction is propagated to all contexts within N−1 levels of the first level.

16. The non-transitory computer readable medium of claim 14, wherein the trusted boundary definition value equals an indication of network-all and the first interaction is propagated to all accessible contexts within the contextual social network, the accessible contexts comprising those contexts with a traversal path to the first context via a context allowing network-all propagation.

17. The non-transitory computer readable medium of claim 14, further comprising instructions stored thereon that when executed by the programmable control device cause the programmable control device to:
maintain a single role relationship between the one or more users and each context to which each of the one or more users is directly associated.

18. The non-transitory computer readable medium of claim 17, wherein the single role relationship comprises a role selected from the group consisting of an owner relationship, an administrator relationship, and a user relationship.

19. The non-transitory computer readable medium of claim 14, wherein the contextual social network represents an educational institution.

20. The non-transitory computer readable medium of claim 19, wherein at least one context of the plurality of contexts represents a class and one or more users associated with the at least one context are students enrolled in the class or parents of students enrolled in the class.

21. The non-transitory computer readable medium of claim 19, wherein at least one context of the plurality of contexts represents a class and a teacher of the class has an owner relationship with the at least one context.

22. A non-transitory computer readable medium comprising instructions stored thereon that when executed by a programmable device cause the programmable device to:
maintain contextual relationships of a contextual social network, the contextual relationships comprising associations between a plurality of contexts and associations between one or more users and each of the plurality of contexts, the plurality of contexts including a first context owned by a first owner and a second context owned by a second owner;
receive an indication of an invitation initiated by the first owner to directly associate the second context with the first context, wherein no prior direct association exists between the first and the second contexts;
send the invitation to the second owner;
receive an indication of acceptance of the invitation from the second owner; and
establish a direct association between the first and second contexts, wherein all members of the first and second context are automatically associated at a maximum trusted boundary definition of level two in addition to any previous association prior to the direct connection association between the first and second contexts.

23. The non-transitory computer readable medium of claim 22, further comprising instructions that when executed by a programmable device cause the programmable device to:
receive an indication from the first owner or second owner to disassociate the first context from direct association with the second context; and
delete the direct association between the first and second contexts, wherein all members of the first and second context are no longer connected via the deleted direct association but maintain all other associations in existence immediately prior to deleting the direct association.

24. The non-transitory computer readable medium of claim 22, wherein the contextual social network represents an educational institution.

25. The non-transitory computer readable medium of claim 24, wherein at least one context of the plurality of contexts represents a class and one or more users associated with the at least one context are students enrolled in the class or parents of students enrolled in the class.

26. The non-transitory computer readable medium of claim 24, wherein at least one context of the plurality of contexts represents a class and a teacher of the class has an owner relationship with the at least one context.
